(19) United States
(12) Patent Application Publication
(10) Pub. No.: US 2006/0168118 A1
(43) Pub. Date: Jul. 27, 2006

(54) Method and system for differential distributed data file storage, management and access

(75) Inventors: Benjamin Godlin, Jersalem (IL); Divon Lan, Tel-Aviv (IL); Yuval Hager, Yafo (IL)

Correspondence Address: Pearl Cohen Zedek Latzer, LLP;Suite 1001, 10 Rockefeller Plaza, New York, NY, 10020, US

(73) Assignee: DiskSites Research and Development Ltd.

(21) Appl. No.: 11/336,858

(22) Filed: Jan. 23, 2006

Related U.S. Application Data
(63) Continuation of application No. 09/999,241, filed on Oct. 31, 2001.
(60) Provisional application No. 60/271,943, filed on Feb. 28, 2001.
(60) Provisional application No. 60/272,678, filed on Mar. 1, 2001.

(51) Int. Cl. G06F 15/16

(52) U.S. Cl. 709/218

(57) ABSTRACT

A method and system providing a distributed filesystem and distributed filesystem protocol utilizing a version-controlled filesystem with two-way differential transfer across a network is disclosed. A remote client interacts with a distributed file server across a network. Files having more than one version are maintained as version-controlled files having a literal base and at least one delta section. The client maintains a local cache of files from the distributed server that are utilized. If a later version of a file is transferred across a network, the transfer may include only the required delta sections.

### CROSS REFERENCE TO RELATED APPLICATIONS

This application claims priority under 35 U.S.C. § 119(e) of U.S. Provisional Patent Application Ser. No. 60/271,943, filed Feb. 28, 2001 and incorporated herein by reference.

A portion of the disclosure of this patent document contains material which is subject to copyright protection. The copyright owner has no objection to the facsimile reproduction by any one of the patent document or the patent disclosure, as it appears in the Patent and Trademark Office patent files or records, but otherwise reserves all copyright rights whatsoever.

### REFERENCE TO CD-R APPENDIX

The CD-R appendix and materials thereon © is hereby incorporated by reference in its entirety. The following is a list of the files, protected by copyright as stated above:

| | | | |
|---|---|---|---|
| 01/20/2001 | 09:13 a | 103,389 | BDIFF.C © |
| 01/20/2001 | 09:18 a | 62,407 | CACHE.C © |
| 01/20/2001 | 09:19 a | 6,622 | DFILE.H © |
| 02/15/2001 | 07:58 a | 11,693 | IAMALIVE.C © |
| 11/21/2000 | 08:11 a | 3,076 | LOST_FIL.H © |
| 02/15/2001 | 10:29 a | 145,073 | MANAGER.C © |
| 01/20/2001 | 09:33 a | 22,032 | STF.C © |
| 02/14/2001 | 09:21 a | 89,739 | USER_FIL.C © |
| | 8 File(s) | 444,031 | bytes |

### FIELD OF THE INVENTION

The present invention relates generally to methods, systems, articles of manufacture and memory structures for storage, management and access of file storage using a communications network. Certain embodiments describe more specifically a version-controlled distributed filesystem and a distributed filesystem protocol to facilitate differential file transfer across a communications network.

### BACKGROUND

There have been considerable technological advances in the area of distributed computing. The proliferation of the Internet and other distributed computing networks allow considerable collaboration among computers and an increase in computing mobility. For instance, it has been shown that many thousands of computers can collaborate in performing distributed processing across the Internet. Additionally, mobile computing technologies allow users to access data using many different computing devices ranging from stationary computers to mobile notebook computers, telephones and pagers. Such computing devices and the networks connecting them generally have differing communications bandwidth capabilities.

Additionally, technological advances in the areas of data processing and storage capabilities have led to greater use of storage resource-intensive applications such as video applications that may require greater communications bandwidth.

Seamless file access may be difficult to obtain when a myriad of implementations are used for distributed file services. For example, a computer user may wish to access files located on an office network from a remote location such as a home computer or a mobile computer. Similarly, a worker in a branch office may require access to files stored at a main office. Such users might utilize one or more of several available communications channels including the Internet, a Virtual Private Network (VPN) over the Internet, a leased line WAN, a satellite link or a dial-up connection over the Plain Old Telephone Service (POTS). Each remote access implementation may be configured in a different manner.

Organizations may utilize independent Storage Service Providers (SSPs) to maintain computer file storage for the organization. Furthermore, individuals often have access to remote storage provided by an Internet Service Provider (ISP). The resulting increase in complexity of administering distributed computing file systems may present a user with a disparate user-interface for connection to data. There may be bandwidth and round-trip latency limitations for storage solutions utilizing wide are networks (WANs) over local hard drive (HD) and local area network (LAN) storage.

Distributed file systems may have characteristics that are more disadvantageous when operating over a greater physical distances such as may exist when operating over a WAN such as the Internet when compared to operating over a LAN. For example, an Enterprise File Server (EFS) may utilize a network filesystem such as CIFS as used with Windows NT®. Another network file system is the Network File System (NFS) developed by Sun Microsystems, Inc. NFS may be used in Unix computing environments. Similarly, another network file system is the Common Internet File system (CIFS) that is based upon the Server Message Block (SMB) protocol. CIFS may be used in Microsoft Windows® environments. For CIFS systems, a CIFS client File System Driver (FSD) may be installed in the Client Operating System Kernel and interface with the Installable File System Manager (IFS Manager). Both CIFS and NFS are distributed filesystems that may have characteristics that are more disadvantageous when operating over a greater physical distances such as may exist when operating over a WAN such as the Internet when compared to operating over a LAN. Other network filesystems, also known as distributed filesystems, include AFS, Coda and Inter-Mezzo, that that may have characteristics that are less disadvantageous than CIFS or NFS when operating over a greater physical distances such as may exist when operating over a WAN such as the Internet when compared to operating over a LAN.

Communication protocols may utilize loss-less compression to reduce the size of a message being sent in order to improve the speed performance of the communications channel. Such compression may be applied to a particular packet of data without using any other information. Such communications channel performance benefits come at the expense of having to perform compression with the delay of coding and decoding operations at the source and destination, respectively and any additional error correction required.

Data compression methods may be used to conserve file storage resources and include methods known as delta or difference compression. Such methods may be useful in compressing the disk space required to store two related files. In certain systems, such as software source code configuration management, it may be necessary to retain intermediate versions of a file during development. Such systems could therefore use a very large amount of storage space. Some form of difference compression may be used locally to store multiple versions of stored documents, such as multiple revisions of a source code file, in less space than needed to store the two files separately. Such systems may store multiple files as a single file using the local file system of the computer used.

The background is not intended to be a complete description of all technology related to the application nor is inclusion of subject matter to be considered an indication that-such is more relevant than anything omitted. The background should not be considered as limiting the scope of the application or to bound the applicability of the invention in any way.

### BRIEF SUMMARY OF THE INVENTION

The present application describes embodiments including embodiments having a filesystem and protocol. Certain embodiments utilize a version-controlled filesystem with two-way differential transfer across a network. A remote client interacts with a distributed file server across a network. Files having more than one version are maintained as version-controlled files having a literal base (a file that is binary or other format and may be compressed, encrypted or otherwise processed while still including all the information of that version of the file) and zero or more difference information (“diff” or “delta”) sections. The client may maintain a local cache of version controlled files from the distributed server that are utilized. If a later version of a file is transferred across a network, the transfer may include only the required delta sections.

### BRIEF DESCRIPTION OF THE DRAWINGS

FIG. 1A shows a high level block diagram of a prior art distributed filesystem;

FIG. 1B shows a high level block diagram of a first embodiment of the present invention;

FIG. 1C shows a high level block diagram of a second embodiment of the present invention;

FIG. 2A shows a block diagram of a file structure according to an embodiment of the present invention;

FIG. 2B shows a block diagram of a file structure according to an embodiment of the present invention;

FIG. 2C shows a block diagram of a representative Base File Section and Diff Section Data according to an embodiment of the present invention shown in FIG. 2B;

FIG. 2D shows a block diagram of a representative Diff Section according to an embodiment of the present invention;

FIG. 2E shows a block diagram of a representative Version-Controlled File and corresponding Plain Text File according to an embodiment of the present invention utilizing a Gateway;

FIG. 2F shows a block diagram of a representative bdiff context according to an embodiment of the present invention;

FIG. 3A shows a table of token types according to an embodiment of the present invention;

FIG. 3B shows a table of subfile reconstruction sequences according to an embodiment of the present invention;

FIG. 3C shows a flow diagram of a patching process according to an embodiment of the present invention;

FIG. 3D shows a flow diagram of a patching process according to an embodiment of the present invention;

FIG. 4A shows a block diagram illustrating the data flow according to an embodiment the present invention;

FIG. 4B shows a flow chart diagram illustrating the process flow of a client read access according to an embodiment the present invention;

FIG. 4C shows a flow chart diagram illustrating the process flow of a client write access according to an embodiment the present invention;

FIG. 5A shows a flow diagram of a speculative differential transfer process according to an embodiment of the present invention;

FIG. 5B shows a block diagram showing files used for a speculative differential transfer process according to an embodiment of the present invention;

FIG. 6A shows a block diagram of a remote client according to an embodiment of the present invention;

FIG. 6B shows a block diagram of a remote client according to an embodiment of the present invention;

FIG. 6C shows a block diagram of a cache server according to an embodiment of the present invention;

FIG. 7A shows a block diagram of a gateway according to an embodiment of the present invention;

FIG. 7B shows a block diagram of a DDFS server according to an embodiment of the present invention;

FIG. 8A shows a flow diagram of file system operation of a prior art distributed file system;

FIG. 8B shows a flow diagram of file system operation according to a first embodiment of the present invention;

FIG. 8C shows a flow diagram of file system operation according to a second embodiment of the present invention;

FIG. 9A shows a flow and state diagram of a physical connection time-out process according to an embodiment of the present invention; and

FIG. 9B shows a data diagram used with a physical connection time-out process according to an embodiment of the present invention.

### DETAILED DESCRIPTION OF EMBODIMENTS

There may be advantages realized by a system that allows seamless access to files distributed across a network. In other words, it may be practical and desirable to have a computing system that can seamlessly access data stored at a remote site such that access to the files is transparent to the user in terms of a transparent user interface (access the files from any application as if they were stored locally) and in terms of performance. Furthermore, efficient distributed sharing of resources such as file storage resources is practical for distributed computing.

Several embodiments are disclosed for illustrative purposes and it will be appreciated that such embodiments are illustrative and that other configurations are contemplated. A description of some characteristics of embodiments described is provided. A distributed file may have at least one copy that is not stored on the user data processor.

Certain embodiments are described as a system having a configuration described as a Differential Distributed File System (DDFS) that have configurations that are illustrative. Accordingly, a DDFS may have configurations that may vary. Certain embodiments are described as using a DDFS Protocol having illustrative characteristics. The systems disclosed may provide practical user interface access and performance access across a network that may approach what conventionally is perceived as “seamless” access to the files when stored locally on a hard drive. Such distributed systems may include client and server components and preferably include a version controlled file system with a local client cache for the version controlled files and differential file transfer across a network when appropriate.

An embodiment disclosing a DDFS system may use a DDFS client directly connected to a network such as a WAN. In such embodiments, the client system operates as a distributed file system client that includes a local DDFS cache and is integrated with or provided on top of the client operating system and local file system. However, it may be preferable if no changes are made to the standard client platform. For example, it may be preferable if DDFS client software is not installed on a client platform. Accordingly, a remote computer may act as a DDFS client or remote user by connecting to a conventional network such as a LAN that may act as a DDFS client when accessing distributed files. For example, the client may utilize a conventional distributed file system to access an intermediate local device on a LAN that can act as a DDFS cache server or intermediary in providing access to distributed files. The intermediary or “cache server” may act as a conventional server by processing file requests from a client using a conventional standard file system protocol and then act as a DDFS client with associated version-controlled filesystem cache when accessing files over a WAN using the DDFS protocol. In such an embodiment, the cache server may employ the same logic as the DDFS client without the client user interface components and with facilities necessary to service a conventional multi-user server. The behavior described in which a client system utilizes a conventional filesystem at an intermediary which utilizes another distributed filesystem to access the files is defined as “tunneling”.

A DDFS system according to the invention may utilize a distributed DDFS file server to store the distributed files in the version controlled format. Such a system may be accessed over a network such as a WAN and operate as a Storage Service Provider (SSP). If such a system is accessed by a DDFS cache server, it is said to be in a “half tunneling mode”.

However, it may be preferable if the distributed files are stored on a conventional file server such as a known reliable Enterprise File Server (EFS) utilizing CIFS or NFS. For example, it may be preferable if the distributed files were stored in a non-version controlled format on an Enterprise File Server that may also be accessed by non-DDFS clients. In such a configuration, the DDFS system preferably includes a Gateway that may act as a DDFS server when accessed across the network such as a WAN by Remote Users (Cache Servers) or Remote Clients and then act as a convention distributed filesystem client such as a CIFS client to access the distributed files across a network such as a LAN. In such an embodiment, the DDFS gateway may maintain version controlled copies of the distributed files and also perform certain DDFS client functions in that it may create differential versions of a distributed file if it is altered by a non-DDFS client. The Gateway may synchronize files with the conventional Enterprise File Server such that newly written version controlled delta sections are patched into a new “plain text” file for storage on the conventional EFS. The term “plain text” is used to refer to a file that is decoded or not delta encoded (could be otherwise compressed, etc.) and while delta compression is a coding, the related cryptography terms of cipher text versus plain text are not meant to necessarily imply cryptography characteristics. The network transmissions utilized, may of course be encrypted as is well known in the art.

Similarly, the Gateway may determine when a distributed file of an EFS is changed by a non-DDFS client and create a new delta version for the Gateway copy. The behavior described in which a Remote User of a conventional client system utilizes a conventional filesystem to connect to an intermediary which utilizes another distributed filesystem that then utilizes a conventional filesystem to access the distributed files is defined as “full tunneling mode”.

Embodiments of the present invention disclosing caching protocols and protocols for creating differential versions of distributed files, caching them and restoring “plain text” versions are disclosed below.

Accordingly, as can be appreciated, the particular DDFS configurations disclosed are illustrative and the DDFS architecture of the invention in its preferred embodiments may utilize one or more client configurations that may include Remote Client and/or Cache Server configurations

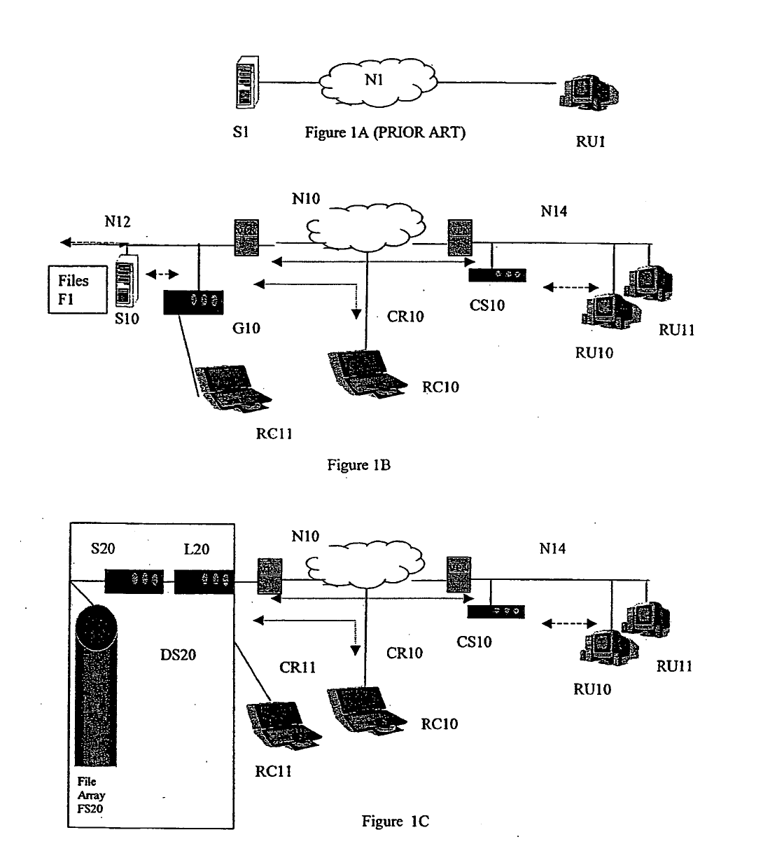

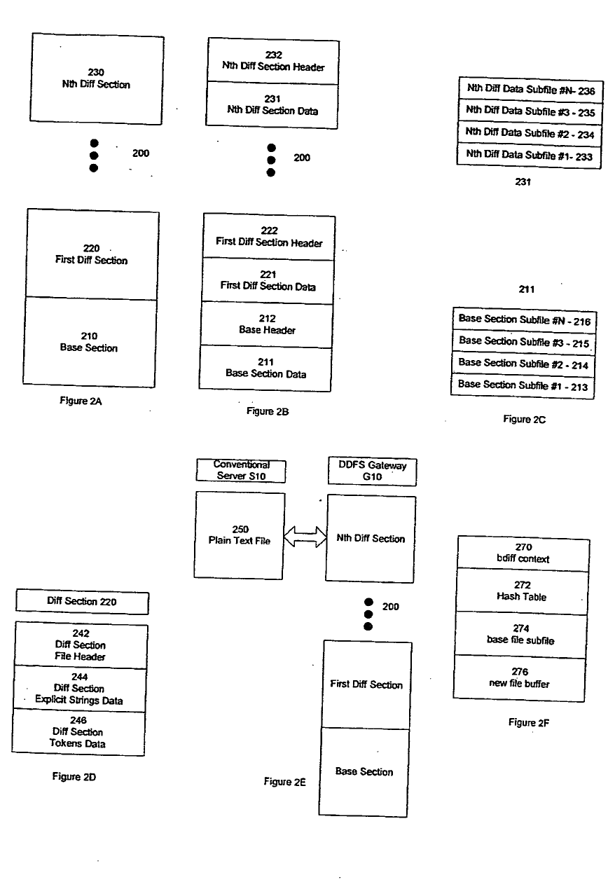

FIG. 1A shows a block diagram of a representative configuration of a prior art distributed file network system. A Remote User Client RU1 is connected to a distributed file server S1 by network N1.

FIG. 1B shows a block diagram of a representative configuration of a first embodiment of the DDFS architecture of the present invention, including a limited number of representative components for illustration. A particular implementation of the DDFS system may not include each of the component types illustrated. The representation is illustrative and a filesystem and filesystem protocol according to the present invention will likely exist on a much larger scale with many more components that may be connected and disconnected at different times. A configuration having a single DDFS client and DDFS server is possible. Similarly, the DDFS server may exist as a gateway to a conventional server or as a dedicated DDFS server.

The DDFS configuration is preferably designed to be flexible and may be easily varied by those skilled in the art. In particular, well known scalability, reliability and security features may be utilized. Similarly, mixed computing platforms and networking environments may be supported.

In the embodiment, distributed files F1 are hosted on a single file server S10 which is preferably a conventional file server using a conventional distributed filesystem and connected to a differential gateway G10 using network N12. The file server S10 may comprise an IBM PC compatible computer using a Pentium III processor running Linux or Windows NT Server®, but can be implemented on any data processor including a Sun Microsystems computer, a cluster of computers, an embedded data processing system or a logical server configuration. The system of the invention may use well-known physical internetworking technology. Network N12 may be implemented using an Ethernet LAN utilizing a common distributed filesystem such as NFS or CIFS, but may be any network. The differential gateway G10 acts as a DDFS file server and may also be directly connected to Network N10. The file server S10 may be fault tolerant and may utilize a common distributed filesystem such as NFS or CIFS. The differential gateway G10 acts as a DDFS file server and may also be directly connected to Network N10.

The differential gateway G10 executes the differential transfer server logic described below (not shown in FIG. 1B) that complies with the DDFS version-controlled filesystem and implements the DDFS two-way differential transfer filesystem protocol. The differential transfer client logic is preferably implemented as software executed on a differential gateway data processor but may also be implemented in software, firmware, hardware or any combination thereof. The differential gateway G10 may be an IBM PC compatible computer using a Pentium III processor, but can be implemented on any data processor including but not limited to a Sun Microsystems computer, a cluster of computers, an imbedded data processing system or a logical server configuration.

A first remote client RC10 acts directly as a DDFS client and is shown connected to network N10 using connection CR10. The remote client RC10 illustrated is a notebook computer, however, a remote client may be any remote computing device with a data processor including, but not limited to mainframe computers, mini-computers, desktop personal computers, handheld computers, Personal Digital Assistants (PDAs), interactive televisions, telephones and other mobile computers including those in homes, automobiles, appliances, toys and those worn by people. Additionally, the above-mentioned remote computers may execute a variety of operating systems to form various computing platforms.

The remote client RC10 executes the differential transfer client logic described below (not shown in FIG. 1B) that complies with the DDFS version-controlled filesystem and implements the DDFS two-way differential transfer filesystem protocol. The differential transfer client logic is preferably implemented as software executed on a remote client data processor but may also be implemented in software, firmware, hardware or any combination thereof and may be distributed on a logical server.

Remote client RC10 is connected to network N10 using connection CR10. The network N10 can be any network, whether such network is operating under the Internet Protocol (IP) or otherwise. For example, network N10 could be an Point-to-Point (PPP) protocol connection, an Asynchronous Transfer Mode (ATM) protocol or an X.25 network. Network N10 is preferably a Virtual Private Network (VPN) connection using TCP/IP across the Internet. Latency delay improvements may be greater as physical distances across the network increase.

Any communications connection RC10 suitable for connecting remote client RC10 to network N10 may be utilized. Connection RC10 is preferably a Plain Old Telephone Service (POTS) analog telephone line connection utilizing the dial-up PPP protocol. Connection RC10 may also include other connection methods including ISDN, DSL, Cable Modem, leased line, T1, fiber connections, cellular, RF, satellite transceiver or any other type of wired or wireless data communications connection in addition to a LAN network connection, including Ethernet, token ring and other networks.

As shown in FIG. 1B, a remote client RC11 may connect directly to differential gateway G10 using connection CR11 which is preferably a Plain Old Telephone Service (POTS) analog telephone line connection. Connection CR11 may also include other connection methods as described above with reference to CR10. The connection CR11 may additionally utilize the N12 network to access gateway G10.

In the first embodiment, remote file users RU10 and RU11 are connected to conventional network N14 which is connected to a DDFS cache server CS10. RU10 and RU11 may include IBM PC Compatible computers having Pentium III processors, but may be any data processing system as described above. Network N14 may be any network as described above with reference to N12. N14 may include a Novell file server. In an alternative, VPNs are not utilized. The DDFS cache server CS10 acts as a transparent DDFS file transceiver in that it acts as a conventional file server to the Remote Users RU10 and RU11 using a conventional distributed filesystem such as NFS, but as described below, utilized DDFS tunneling to access DDFS distributed files across a network. The DDFS cache server CS10 acts as a DDFS client when accessing the DDFS distributed files across a network. The DDFS cache server CS10 may also be directly connected to Network N10.

The DDFS cache server CS10 executes cache server logic (not shown in FIG. 1B) that includes differential transfer server client logic described below that complies with the DDFS version-controlled filesystem and implements the DDFS two-way differential transfer filesystem protocol. The cache server logic also preferably includes the DDFS tunneling logic described below. The cache server logic is preferably implemented as software executed on a cache server data processor but may also be implemented in software, firmware, hardware or any combination thereof and may be distributed on a logical server.

The DDFS cache server CS10 may be an IBM PC compatible computer using a Pentium III processor, but can be implemented on any data processor including a Sun Microsystems computer, a cluster of computers, an imbedded data processing system or a logical server configuration. Remote Users RU10 and RU11 may also connect to differential cache server CS10 using other connection methods described above.

As can be appreciated, remote user RU10 operates on Files F1 using “full tunneling” through cache server CS10 and Gateway G10. Remote Client RC10 operates on Files F1 using a server side “half tunneling” through Gateway G10.

With reference to FIG. 1C, a second embodiment having a representative configuration of a DDFS distributed filesystem is shown. The distributed files may be hosted on a native DDFS differential file server DS20. A load balancer L20 may be connected to a Server Processor S20 connected to a file storage array FS20. As described above, various platforms may be utilized for these components including Linux based platforms and various interconnections may be utilized. The other components of this embodiment operate essentially in accordance with the descriptions thereof above with reference to FIG. 1B. Various known file storage technologies may be utilized. For example, several physical computers or storage systems may be used. Logical file servers can be utilized as well with fault tolerance and load balancing. Similarly, a combination of native hosting and gateway hosting may also be utilized. As disclosed above, such a system would employ a half tunneling mode when accessing files using the Cache Server CS10.

As can be appreciated, remote user RU10 operates on File Array FS20 using a client side “half tunneling” through cache server CS10. Remote Client RC11 operates on File Array FS20 using no tunneling.

As can be appreciated, most of the protocols and processes described below may apply to the first and second embodiments wherein a preferred embodiment may be utilized for both. However, as can be appreciated, full tunneling and the gateay are applicable to the first embdoiment and non-gateway protocols are applicable to the second embodiment.

As can be appreciated, alternatives for a particular component or process are described that constitute a new embodiment without repeating the other components or processes of the embodiment.

Referring to FIG. 2A, the structure of a representative file 200 is shown in the first and second embodiment of the DDFS filesystem. As with some conventional file systems, directories are preferably stored as files. The filesystem is preferably version-controlled such that each file or directory has a version number associated with it, and each version of the file stored has a unique version number for the specific version of the file, represented by a variable “vnum”. The version number prefereably increases with every change of the file and is preferably implicitly determined by counting the number of file differences stored or by utilizing an explicit version number variable.

The DDFS structure stores files in a linear difference format and preferably does not utilize branches. Each file is comprised of a base section 210. If a file has been changed, it will have a corresponding number of difference (diff) or delta sections, First Diff Section 220 through Nth Diff Section 230. The diff sections contain the information necessary to reconstruct that version of the file using the base section 210 or the base section and intermediary diff sections.

The base section 210 preferably contains literal data (a “plain text” file that is binary or other format and may be compressed, encrypted or otherwise processed while still including all the information of that version of the file) of the original file along with the base vnum (not shown in FIG. 2) of the file. If there are no diff sections for a file, the base vnum is the vnum of the file. Each diff section added increments the vnum of the file.

Referring to FIG. 2B, the structure of a representative file 200 is shown in greater detail as base section 210 includes a base data section 211 and a base header 212. Similarly, the First Diff Section (and subsequent sections) include a data section 221 and a header 222.

Referring to FIG. 2C, the structure of a representative base section 211 is shown in greater detail and includes base data section subfiles 1 through N, 213-216 and a representative diff section data 231 includes diff data subfiles 1 through N, 233-236.

Referring to FIG. 2D, the structure of a representative diff section 220 is shown in greater detail and includes a tokens data section 244, a Explicit Strings data section 244 and a file header 242.

Referring to FIG. 2E, the structure of a representative Version-Controlled File and corresponding Plain Text File on a gateway filesystem according to an embodiment of the present invention is shown. Conventional Server S10 stores a plain text file 250 that corresponds to file 200 stored on DDFS Gateway G10.

Referring to FIG. 2F, the structure of a representative bdiff context according to an embodiment of the present invention is shown. Bdiff context 270 includes hash table 272, base file subfile 274 and new file buffer 276.

A DDFS system in another embodiment maintains information regarding client access to the distributed files and when appropriate, collapses obsolete delta sections into a new base version of the distributed file. Similarly, another embodiment using a DDFS system utilizes unused network bandwidth to update client caches when a distributed file is changed. Such optimizations may be controlled by preference files for a client or group of clients that may be more likely to request a certain distributed file.

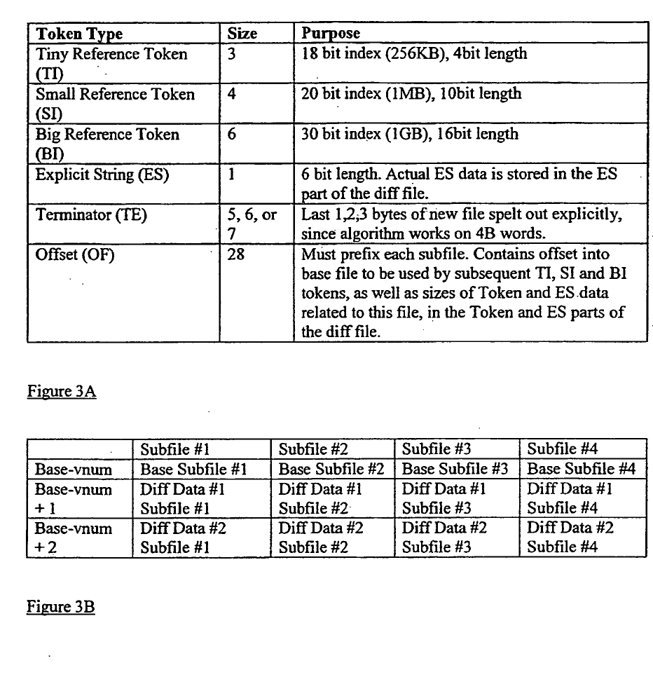

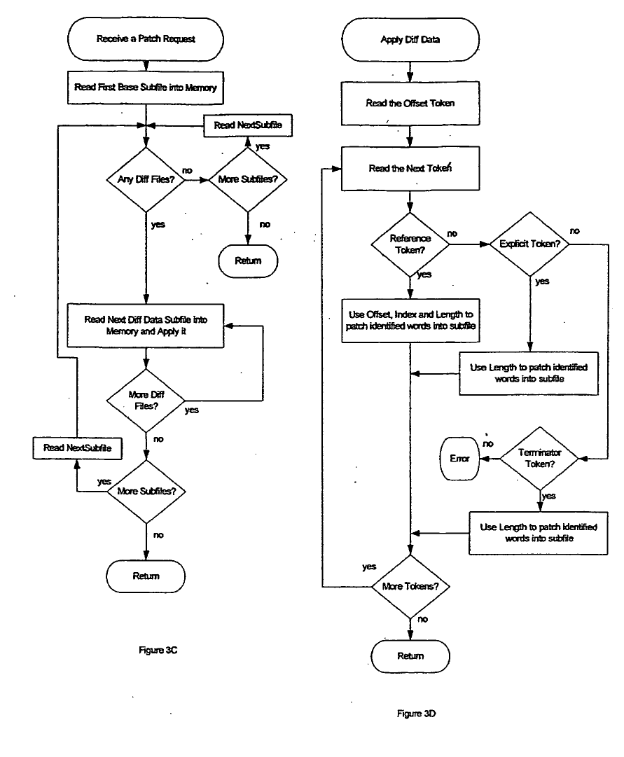

Referring to FIGS. 3A and 3B, a Binary Difference Process for the first and second embodiments is described for use with a DDFS system configuration. The filesystem and protocol of the present embodiment utilize a system for determining the differences between two files. The difference system determines the differences in such a way that “difference information” such as “diffs,” or “deltas” can be created which may be utilized to recreate a copy of the second file from a representation of the first file.

In certain embodiments, a diff file is used to patch together the second file by patching string of the first file with strings in the diff file. As can be appreciated, a difference system may operate on various types of files including binary files and ASCII text files. For example, the UNIX DIFF program operates on text files and may utilize text file attributes such as end of line characters. Furthermore, a difference system may determine difference information as between two unrelated files. In a version-controlled filesystem, the difference system may operate on two versions of a file. Additionally, a difference compression process need not process the file in the native word size. The difference system of the present invention preferably utilizes two versions of a binary file. In another preferred embodiment referred to as a speculative mode of a difference system, the difference system is utilized to determine if two files may be considered two versions of the same binary file. The difference information could be expressed in many forms including an English language sentence such as “delete the last word”. Files are commonly organized as strings of “words” of a fixed number of binary characters or bits. As can be appreciated, variable length words are possible and non-binary systems may be utilized. As can be appreciated the difference system may utilize differing word sizes than the “native” or underlying format of the first and second files. The difference information is preferably binary words of 64-bit length.

As can be appreciated, the difference system expends computing resources and time to perform its functions. Accordingly, there is a trade-off between difference information that is as small as possible and creating the difference information and patching files in the least amount of time possible. The difference system and patch system are preferably related by the filesystem format such that the difference information determined by two different difference systems may be utilized by the same patch system. Additionally, the filesystem format is preferably capable of ensuring backward-compatibility with later releases of a difference system and preferably capable of being utilized by more than one difference system or more than one version of difference logic of a difference system. For example, the filesystem format preferably supports a difference/patch system that applies increasingly complex logic as the binary file size increases. The difference/patch system preferably employs logic in which the time complexity is not greater than linear with the file size. Using Big Oh complexity notation, such a system is said to have linear complexity O(n), where n is the file size.

Referring to FIGS. 3A and 3B, a Binary Difference Process of a first and second embodiment utilizes Token Based Difference Information. The difference information is expressed using “tokens”. The difference information is an array of “tokens” which may be either “reference tokens” or “explicit string tokens”. By combining or patching the diff tokens with the representation of the first file or the base file, the second file or new file can be reconstructed. The reference tokens include an index value and a length of a string value related to the base file. Explicit strings are used when a certain string in the new file cannot be found anywhere in the base file and they include the explicit words.

The following example is utilized to illustrate certain aspects of difference protocol that may be utilized. As can be appreciated, different difference protocols may be utilized in other embodiments.

### EXAMPLE 1

| | |
|---|---|
| Base File: | A B C D E F G H I J K L M N O P Q R S T |
| New File: | F G H I C D E F G X Y G H |
| Diff: | Reference (index = 5, length = 4); ref (2, 5); |
| | Explicit (length = 2)“X Y”; Ref(6, 2) |

In Example 1 above, binary words (the length in bits may be set or varied) are represented by unique letters in a base file. Certain words are repeated in the New file and some strings of words are repeated. The first reference token means that the new file starts with a string of words that starts at the sixth word and continues four words, e.g., the 6^{th}, 7^{th}, 8^{th} and 9^{th} words “F G H I”. As the word sizes are not necessarily that of the underlying file system, the “A” word in not necessarily the 64 bit word used by NTFS.

As can be appreciated, in other embodiments, separate threads of a reconstruction program could work in rebuilding various sections the new file. Similarly, the characteristics of random access media such as magnetic disk drives along with information regarding the characteristics of the local file system may allow reconstruction schemes that do not linearly traverse the new file.

Accordingly, with a known base file and the diff we could recreate the new file (a process known as patching) by traversing the diff from start to end, and outputting the characters of the new file, the following way: First token is a reference (5,4). Copy the string from the base file starting at index 5, and having length 4. This would output “F G H I”. Similarly, process the second token reference (2,5). This would output “C D E F G” Process the third token, which is an explicit string. Just copy it to the output: “X Y”. The forth token reference (6,2) will output “G H”.

Referring to FIG. 2D, a preferred Diff file is disclosed. A single diff file including subfiles contains Difference Information between the base file and the new file. This diff file has three parts including a file header, the Explicit Strings part and the Tokens part.

In a preferred embodiment, the diff file is optionally encrypted such that the encryption key is kept as part of the file header and only the other parts are encrypted. The user may set an encryption flag. Furthermore, the Diff file may also be compressed. In a preferred embodiment, the Explicit Strings part of the file is compressed separately from the Tokens part of the file.

In the preferred process of creating Difference Information, a constant amount of memory (O(1)) memory ) is utilized. For a particular computing platform, memory allocation (including associated paging activity) may be the most time-consuming phase in the diff creation and patching processes.

In a preferred embodiment, the Diff process randomly accesses the base file which preferably resides in local memory such as Random Access Memory (RAM). For a preferred embodiment utilizing a Hash table working file, the size of the hash table is preferably proportional should be proportional to the size of the base file which is mapped into it.

In one embodiment, the entire base file is processed with the entire new file to create a Difference file.

In the first and second embodiments, the base file and new file are practically unlimited by size and a subfiling approach is preferably utilized. In this embodiment, the base file and the new file are divided into subfiles, which may be of uniform size, for example 1 Mbyte each. The base file subfiles are separately processed with the respective new file subfile. For example, the first subfile of the base file is diffed with the first subfile of the new file. Of course, data moved between subfiles will not be considered for matching strings. In this embodiment, a pre-allocated number of bdiff contexts may be utilized. Each bdiff context is about 2.65 MByte in size and contains all the memory required in order to perform one diff process or one patch process. In this embodiment, during the first diff process phase, this memory is used to accommodate a hash table of approximately 512K entries of 3 bytes each (totaling about 1.5 MB), the entire current base file subfile (1 MB) and a buffer used to read in the new file data.

The logic disclosed may be implemented in many forms and may vary for supported platforms. In a preferred embodiment, threads and bdiff contexts are utilized. The number of required bdiff contexts required are preferably allocated at initialization of the entire module—such as the Client Logic DDFS client Logic File System Driver (DDFS Client FSD).

In this embodiment, when a Diff or Patch routine begins, one of the bdiff contexts is allocated to the current operation in a round robin process. During the operation, the bdiff context is preferably protected from concurrent use by other threads by grabbing a mutex. The number of bdiff contexts allocated is preferably determined according to three parameters. First, the number of concurrent diff or patch operations expected for a module such as a DDFS Remote Client. For example, there may not be more than one concurrent operation for such a module, so a single context might suffice. However, the number of contexts may be customized for an implementation. Similarly, a DDFS Cache Server may require more than one. Secondly, the number of processors available is considered. The module preferably has no more than 3-4 contexts per processor allocated because the diff algorithm may be considered CPU intensive and I/O intensive and a greater number may cause bdiff threads to preempt each other. Finally the amount of memory available is considered, particularly for platforms that keep this memory locked (i.e. non-pageable).

Referring to FIGS. 3A and 3B, the first and second embodiment utilizing a process for creating Diff files is described. A single Diff File is created by utilizing a first difference process phase and a second difference process phase separately for each subfile (if subfiles are used).

The output of these phases is comprised of two intermediate files known as the Explicit String file and the Intermediate Tokens file. The output of the first phase and second phase processing of each subfile pair is concatenated to the two output files such that only two intermediate files remain even if there were multiple subfiles. In the Token File, each subfile begins with an offset token that may be utilized by the patch process to determine the beginning of a new subfile.

The third phase converts the Intermediate Token File into the final highly-efficient Token part of the diff file. This is done by using the minimum amount of bytes of each token type. Reference tokens are replaced by with Tiny, Small or Big reference tokens, consuming 3, 4 or 6 bytes respectively.

Referring to FIG. 3A, representative token types of a first and second embodiment are disclosed. The Index parameter is relative to the subfile offset that is obtained from the last OF token. The Length is preferably in 4 Byte words. In another embodiment, the long index BI is a 20 bit index, 18 bit length (total size=5 B) and can address the full subfile 1 MByte.

In a preferred embodiment, tokens are utilized to define difference information. As can be appreciated, the tokens may be determined by different methods. Similarly, different methods may produce different tokens for the same base and new files.

In one embodiment, tokens are created by utilizing a known greedy algorithm. In this embodiment, the new file is traversed from beginning to end, and matching strings are sought in the base file. For example, exhaustive string comparisons are utilized to locate the longest string in a base file that matches a string beginning at the current position in new file. This embodiment involves a quadratic computational complexity O(N²) and may have too great a computational complexity, particularly for a large file or subfile size N.

In another embodiment, tokens are created by utilizing a local window to search for strings that is somewhat similar to the known LZH compression algorithm. However, this embodiment may involve too great a computational complexity, particularly when changes in the new file are not generally local.

In the first and second embodiment, a Hash table and Hash function is utilized. Many different Hash table sizes and Hash functions may be utilized. In a preferred embodiment, the operation of locating a matching string in the base file is completed with a constant time complexity O(1), regardless of the file size. In this embodiment, the matching string found is not necessarily the longest one existing, and matching strings that exist may not be found.

In a first step, a hash table is created by traversing the base file. Hash table hash, is an array of size p, a prime integer. Each of it's entries is an index into the base file. For each word w at index i of the base file, hash is defined as: hash[w mod p]←I.

In a second step, an intermediate token file is created. First, the new file is traversed word-by-word. For each word w at index j in the new file, the longest identical string is calculated, starting for index j in the new file and from index i=hash[w mod p] in the base file. If such string exists with a forwards length forward_length, we also calculate the backward length backward_length of the identical strings starting exactly before index i in the base file and index j in the new file and going backwards. The result is output as a reference token: reference (index=i, forward=forward_length, backward=backward_length). If no such matching string exists, we output an explicit string token: explicit string (w).

The Word Size is preferably 64-bit (8 B) word size for w. This is an empirical result of testing. Words of smaller size may cause considerably shorter matching strings. For example a 4B word size applied to Unicode files (e.g. Microsoft® Word®) may cause all occasions of similar two-character strings (two Unicode letters are 4 B) to be mapped to the same hash table entry. In this embodiment hash conflicts or clashes are not re-hashed but discarded.

The Hash table size is preferably a prime number close to half the size of the files being diffed. A prime number p allows the use of a relatively simple hash function, named “mod p”, such that for arbitrary binary data representing common file formats, there is rarely two 8 B words having the same mod p value. The hash table size involves a trade off of memory consumption and hash function clashes.

The diff process operates on the binary files using an 8 byte word size, but the files (new and base) could be of a format that uses a smaller word size—even 1 Byte. For example, in an ASCII text file, inserting one character causes a shift of the suffix of the file by one byte. To overcome this problem, the hash creation step above in the first step is preferably calculated using overlapping words. For example, the 8 Byte word starting at the first byte of the file and then the 8 Byte word starting at the second byte of the file are processed. Because the hash file is calculated with overlapping words the new file may be traversed word by word rather than byte by byte.

If the new file or base file are of length that is not a multiple of the word size, then the partial terminating word is ignored when calculating the hash table and for reconstruction, the terminator token includes the final bytes. The explicit strings words are preferably buffered and written to an explicit string token just before the next non-explicit string token is written, or alternatively, when the buffer reaches 64 words.

The second step described above creates two files including the intermediate token file and the explicit string file that contains the actual explicit string data (the explicit string tokens are written to the token file).

In a preferred embodiment, 0-runs are treated as a special case. Files often have long “empty” ranges—i.e. ranges in which the data is 0 (“0-runs”). When a hash table is created, hash[0] has the index of the longest 0-run in the file, not necessarily the first occurrence of a word w that has w % p=0, as with all other hash entries.

In these embodiments, a second phase of the “diffing” process is optimizing the Intermediate Token file. In this particular hash implementation, if the base file contains several words that map to the same hash entry (be it because the same word appears several times in the file, or because two different words happen to map to the same hash entry), then the first word gets an index into the hash file, while the subsequent words are ignored. Then, in the second step, when coming across a word that maps to that hash entry, we attempt to find the longest string in base file that starts from the index that happened to get into this hash entry—which is not necessarily the index that would have led to the longest matching string.

However, the diff process disclosed converges. In other words, if base file and new file have a long matching string, then even if the first few words of the string result in short reference tokens or even explicit string tokens due to the above mentioned problem, once a word of the matching string in base file is indeed the word found in the hash table, the remainder of the matching string will be immediately outputted as one reference token.

### EXAMPLE 2

| | |
|---|---|
| Base File: | A B C D E F G H I J K L M N O P Q R S T |
| New File: | B C D E F G H I J K L M N |

As shown in Example 2, we assume that there is a hash table of three entries. Assuming that A % 3=B % 3=C % 3. A, B, and C represent one 8 B words, the first process step is shown in diagram form as follows:

Hash[A % 3] = Hash[0] = 0
Hash[B % 3] = Hash[0] --- ignored. Hash index 0 already occupied.
Hash[C % 3] = Hash[0] --- ignored. Hash index 0 already occupied.
Hash[D % 3] = Hash[1] = 3

In this case, the hash table for the two first words of the new file contains an index to a string that doesn't match these words at all (the string in the base file begins with “A” whereas the strings in the new file begin with either “B” or “C”. Only the when step 2 reaches the third word, namely “D”, in the new file, does it find a matching string in the base file. This is because Hash[D % 3] contains an index to a base file string that begins with “D”. The result of step 2 will be:
Explicit string (len=2) “B C”
Reference (index=3, forward_length=11, backward_length=2)

Note that by the fact the this reference token has a backward_length=2, it is known that the matching string actually started two words before the index discovered. As the length of the explicit string preceding this reference token is exactly 2, we could have optimized these two tokens into one token: Reference (index=3−2, forward_length=11+2, backward_length=2−2), thereby eliminating the explicit string token.

In the optimization phase of the diff algorithm, we traverse the intermediate token file in reverse (from end to beginning), searching for opportunities to do these kinds of optimizations. In typical cases, this optimization eliminates 10%-30% of the tokens, and 5%-10% of the explicit string data.

When reading the intermediate token file from end to beginning, we read it buffer-by-buffer. When a token is eliminated, the token file is not condensed (for the sake of I/O)—rather the eliminated token is replaced by a new token called an overridden token (not shown in FIG. 3A). In addition, a bitmap of the explicit string file in maintained in memory with one bit representing each 8 Byte explicit string word. If this overridden token is an explicit string, then all the words of this explicit string are marked as overridden in the bitmap. Finally, just before this phase ends, the explicit string file is read into memory, and then re-written to disk—but only those words that are not marked in the bitmap as overridden are actually written back.

Referring to FIGS. 3C and 3D, a reconstruction process utilized in the first and second embodiments is disclosed. As described above, the difference information may take different forms including English language prose. In such a case, the prose would be interpreted for instruction and those instructions followed to reconstruct the new file from the base file and the difference information. However, the difference information is preferably in the form difference data sections including tokens. These tokens preferably include Reference tokens, Explicit String tokens and Terminator tokens. Additionally, in an embodiment utilizing sub-files, an Offset token.

Referring to FIGS. 3C and 3D, a reconstruction process is disclosed used in the first and second embodiments. In a preferred embodiment, a process for reconstructing or patching is utilized to reconstruct a version of a file, from a base file and one or more diff files. The version reconstructed is preferably the latest version and is preferably reconstructed vertically by utilizing a bdiff memory context to reduce input/output operations. The Base file section and each Diff Data section are divided into subfiles. Processing the diff files vertically includes processing each diff subfile version in ascending order for each corresponding subfile by patching the base with each one of the diffs and then outputting the new file subfile after applying all diff patches.

A first subfile of the base file is read into memory. Then subfile #1 of diff data #1 is read and patched into the base subfile, resulting in a memory resident Base-vnum+1 version of that subfile. Then subfile #1 of diff data #2 is read and patched into the result of the first patch. After all patches of subfile #1 are completed, the new file version of the subfile is output. Thereafter, remaining subfiles are processed. As can be appreciated, parallel processing may be applied to this process.

The patch process begins by reading an offset token, then each of the following tokens. For Reference tokens, including TI, SI and BI tokens, the offset, index and length parameters are used to determine data from the base file to copy to the current file. For Explicit String tokens ES, the data for the current file is in the explicit string data portion of the diff data file. Similarly, for Terminator tokens, TE, the data for the current file is in the TE token.

In an embodiment, the difference information is compressed. The difference information is preferably compressed using conventional zlib compression, which is a combination of Lempel-Ziv and Huffman compression. Experimentation using zlib compression with the preferred difference system provides typical compression ratios of x1.1 for the ES and x1.3 for the token. In another embodiment, direct Huffman compression is utilized. As can be appreciated, additional compression methods may be utilized

In another embodiment, the difference system identifies the amount of CPU data cache and Level 2 cache and chooses the difference logic accordingly and may choose the subfile size accordingly. In another embodiment, representative files of difference information are stored and used to determine the token used. In a preferred embodiment, the hash file entries are three 8 bit bytes used for an index in the range of 0 through 2²⁰−1. In another embodiment, the hash table entries can reduced to 2.5 Bytes instead of 3 Bytes. This embodiment may incur a performance reduction due to data access at half-byte boundaries, but will reduce the memory for a bdiff context by 0.5 MB.

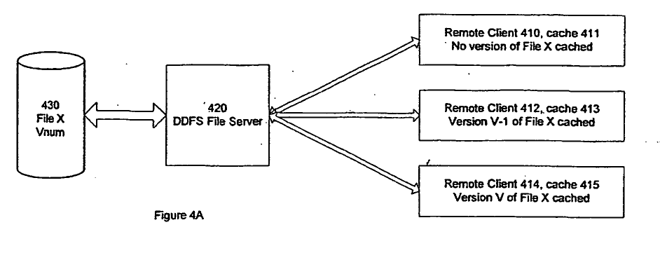

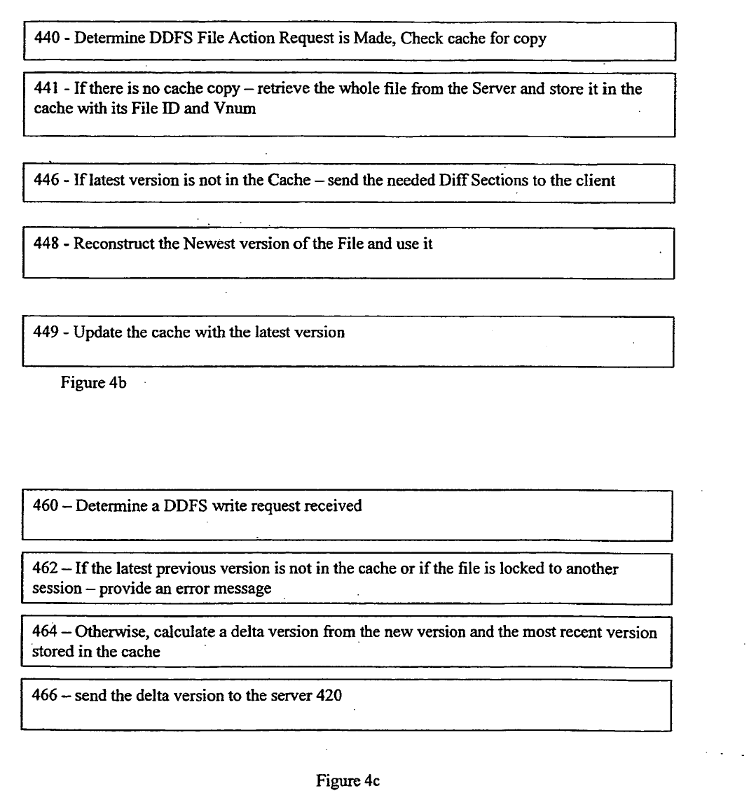

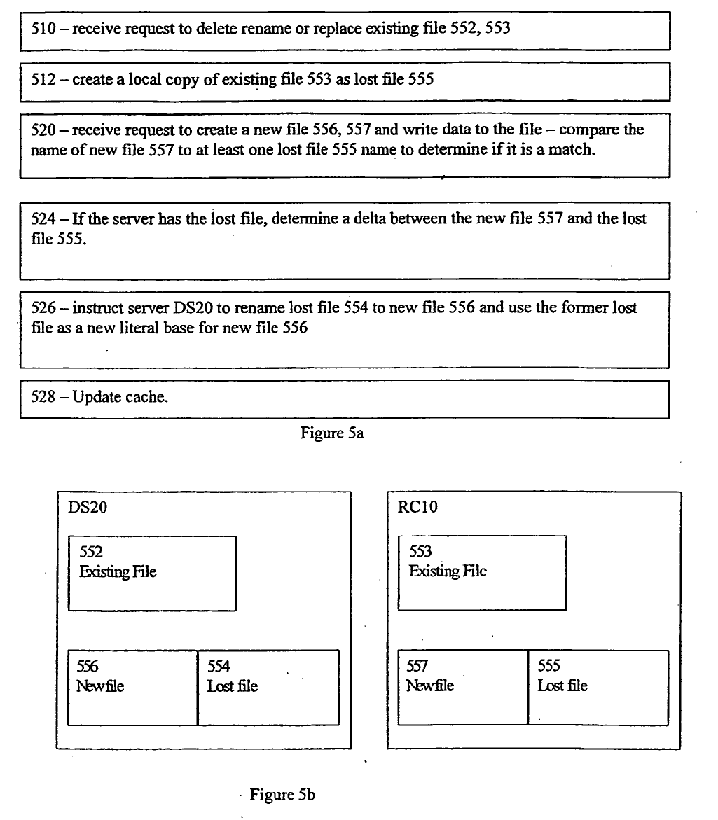

FIG. 4A shows an embodiment of the DDFS filesystem protocol by way of several examples of a two-way differential file transfer protocol that refers to the remote clients of the first and second embodiments that include client logic. The differential transfer protocol is preferably a two-way differential transfer protocol, however, in a system such as one having an asymmetric communications channel, the transfer may be differential in one-way only.

In general a client sends a file open request to the server and specifies the vnum of the file. The server then sends back whatever diffs are needed—all in one response. If the file is opened for write access, then it is locked on the server. If a client is going to commit a file, it knows that it has the latest prior version of the file in the cache and that it is locked (unless the lock has degraded due to a timeout described below). Accordingly, it can then commit the file by calculating a diff if needed and sending the diff to the server. If a client has a file openned for write and it is locked on the server, a client may locally use the cache to respond to another open command without going to the server.

As can be appreciated, a user application such as a word procesing program may be utilized to store files on a distributed server. Accordingly, the application may wish to “commit” a file to the remote storage and will usually wait for a response from the remote server indicating that the file was safely astored. While waiting for such confirmation is not necessary, it is preferred. As shown below with refrence to the Gateway G10, a “done” response is preferably not sent by the Gateway to the user until the Conventional File server S10 reports that the file was safely stored. Similarly, certain network file system protocols and/or applications may be “chatty” when performing such remote file storage operations in that they may commit portions or blocks of a file and wait for each portion to be safely stored which increases latency due to the time needed for each round trip transfer of information. For example, a word processing application may execute several write commands for blocks of a certain size to later commit the file. Bulk transfer allows a single transfer when the file is committed. Accordingly the plurality of block write commands may be accumulated locally and then committed when the application finally comits the file. Local write confirmation may be provided for each block written before the file is commited, thereby reducing latency.

For example, in the CIFS protocol, the client may request a file open, write or commit. Each operation will go to the server even if there are many write block operations. The DDFS protocol may fetch the entire file on an open command and store it locally in the cache. Read and write commands may be handled locally by the client giving responses to the application as needed. Only the commit command will require the data be sent to the server and it can be done as a bulk transfer. If a Cache Server is utilized, the cache server will handle requests somewhat locally from the CIFS server and the CIFS server will send confirmations to the client application.

The DDFS protocol preferebaly utilizes block transfer of files to reduce latency. Similarly, compression techniques may be utilized.

An illustrative DDFS configuration has three clients 410, 412 and 414 connected to the DDFS server 420. File storage 430 is connected to the DDFS server 420. The specific components used are not specified as the configuration is only used to explain the data flow. For example, the client could be a cache server that services several remote users.

Clients 410, 412 and 414 such as DDFS clients and DDFS Cache Servers, maintain a respective cache 411, 413 and 415 of at least one DDFS distributed file accessed during its operation. The cache is preferably maintained on hard disk media but may be maintained on any storage media, including random access memory (RAM), nonvolatile RAM (NVRAM), optical media and removable media. A version number is associated with each file or directory saved in the cache.

As shown in FIG. 4A, differential file retrieval is explained. If a client 410 does not have a requested file in cache, it receives the entire file from the DDFS server 420. If client 412 has a version v-1 of the requested file, only the diff (delta) sections needed to bring the cache version v-1 to the current version are sent from server 420. If client 413 has the current version of the requested file in cache 415, then no delta section needs to be sent across the communications channel. The file write process involves determining a diff if needed and transferring the diff to the server. If the file is not on the server, of if the diff is too large, then the entire file is sent to the server.

As can be appreciated, different cache strategies may be implemented for different embodiments of in the same embodiment. For instance, the cache size may be automatically set or user controlled. For instance, the cache size may be set as a percentage of available resources or otherwise dynamically changed. Similarly, a user may set the cache size or an administrator may set the size of the cache. In this embodiment, a default value of the cache size is initially set for a particular cache server or client and the user may change the value. Such a default cache limit may be based on available space or other factors such as an empirical analysis of the file usage for a particular client or a similar client such as a member of a class of clients. Furthermore, the size of the cache may be dynamically adjusted during client operation.

In this embodiment the cache preferably operates as long term nonvolatile caching using magnetic disk media. As can be appreciated, other re-writable nonvolatile storage media including optical media, magnetic core memory and flash memory may be utilized. Additionally, volatile memory may be appropriate for use as a cache.

Cache systems are well known and many cache protocols may be utilized. In a preferred embodiment, the cache is organized as a Least Recently Used (LRU) cache in which the least recently used file is deleted when space is needed in the cache. An appropriate size cache will allow a high incidence of cache hits after a file has been accessed by a client. As can be appreciated, a file that is larger than the allocated cache size will not be cached.

Furthermore, cache optimizations are possible. For example, a client may select certain distributed file folders to be always cached if space permits. Unused bandwidth may be used for such purposes. Similarly, a client may be pre-loaded with file that it is likely to require access to. Additionally, while a client is operating, a cache optimization system may look to characteristics of file being used or recently used in order to determine which files may be requested in the future. In such a case, certain network bandwidth resources may be utilized to pre-fetch such files for storage in the cache. As can be appreciated, a cache protocol may be utilized that differentiates between the actually used files and the pre-fetched files such that the pre-fetched files are kept only a certain amount of time if not used or are generally less “sticky” in the cache than previously used files.

FIG. 4B illustrates how the client preferably processes a DDFS file read request. First, in step 440, client 410, 412 and 414 (or a Cache Server). determines that a DDFS file has been requested and sends the DDFS server 420 (DDFS File Server or a DDFS Gateway) the file identifier and Version Number (‘Vnum’) of the file currently in cache 411, 413 and 415. In step 441, the server 420 sends the whole file if needed. In step 446, the server 420 decides if any diffs are needed and sends them to the client. If no diffs are needed, the response is preferably in the form of transmitted data indicating that, but may also be any indication including the passing of a period of time without a response. If the latest version is in the cache, the client will utilize the version stored in the cache. If there is a more recent version on the server 420, in step 446 the server sends and the client receives the delta (“diff”) between the latest version, and the version that the client has cached. The delta is composed of all the diff pairs 221, 222 and 231, 232 created between the version stored in the clients cache 411, 413 and 415 and the latest version. The client 410, 412 and 414 then reconstructs the latest version of the requested file in step 448. The client applies the diff pairs to the cached version serially and updates the vnum to the latest version. In step 449, the client may replace the old cached version with the reconstructed version and passes the reconstructed version to the client computer. The art of reconstructing files from delta data is disclosed with reference to the reconstruction protocol.

If the client knows that it has the latest version of a file in the cache, it may locally respond to a file read or open request. As can be appreciated, a read protocol may be utilized that determines whether more than one delta section is required. The read protocol may recalculate a single delta section based upon more than one delta section and then send only the new delta section.

FIG. 4C illustrates how the client processes a “write” request in accordance with the first and second embodiment of the invention. As disclosed, computer file systems may distinguish between writes and committing files. As discussed regarding block transfers, the DDFS system may locally process block write requests and then transfer a file in bulk when it is committed.

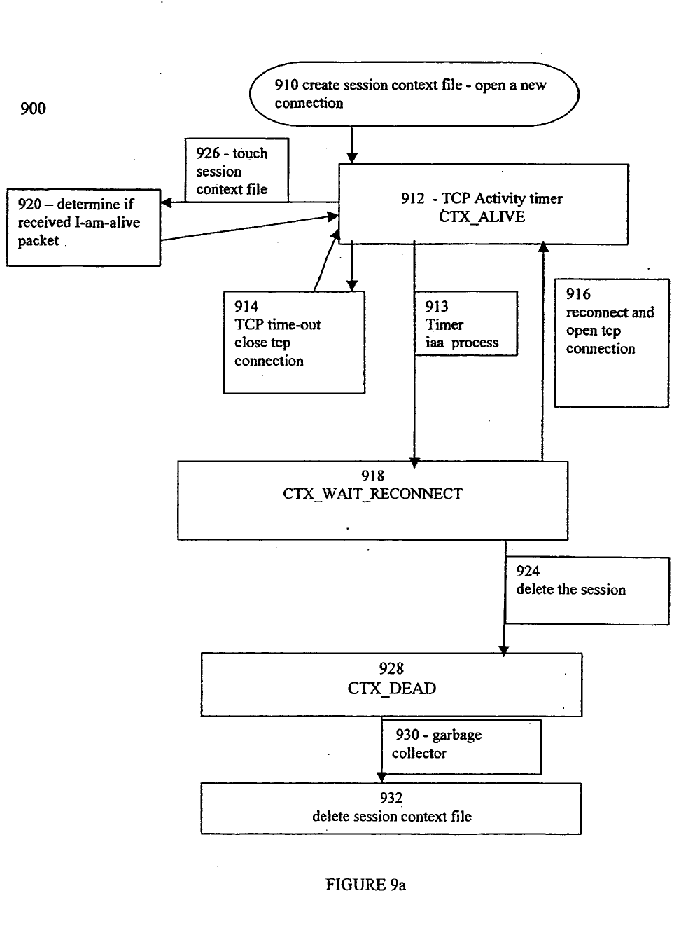

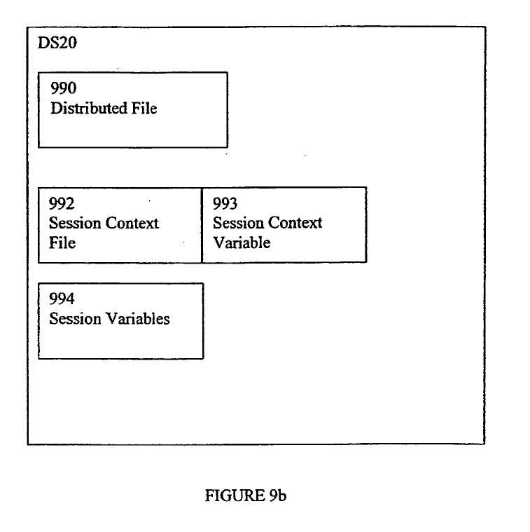

First, in step 460, the client determines that a DDFS file commit has been requested and assumes that it has the latest previous version of the file in its cache because it has the file opened for write and it should be locked. If, as described below with reference to time outs of FIG. 9, it is not the latest version, the client, in step 462, processes an error message. Otherwise, in step 464, the client calculates a delta from the new version and the most recently saved version from the cache 411, 413, 415 (if needed and if small enough). In step 466 it sends the delta (diff) between the new version and the latest saved version to the server 420 to write. The server 420 than stores the delta it received from the client to the file, and implicitly increments the version number. As described with reference to a gateway, it may then create a plain text version for storage on a conventional file server. The application is generally not informed that a successful write occurs until the file is saved on the server. Similarly, intermediate block write commands may be processed locally by the client before a file is committed.

As can be appreciated, a client may desire two file save operations on the same file in a relatively short period of time. Another embodiment may process a plurality of save requests using the local cache to combine versions that may be later sent to the distributed file server. Similarly it may be possible to utilize parallel processing to queue file requests. However, it is preferable to maintain data integrity by completely processing each file request all the way through to the distributed file server if necessary before returning control to the client application process.

As can be appreciated, a file may committed for the first time and not exist on the server. If a new file is opened for write, the server may create the file.

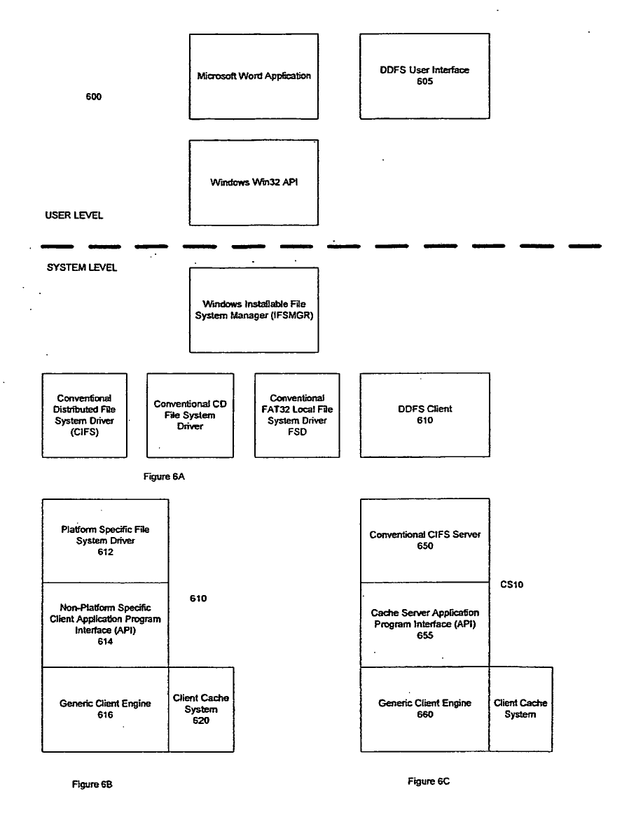

FIGS. 5A and 5B show another embodiment using the DDFS protocol and using the same components as FIG. 4A providing speculative differential file transfers. Application programs may use complex methods for accessing files for purposes such as to restore from catastrophes, backup purposes or others. From a file system perspective, the aforementioned operations are a set of different operations on different files. Accordingly, it is possible to speculate that a differential transfer protocol may be applied using similar files instead of different versions of the same file.

For example, several scenarios for operations on files are described as examples. If a first file named X is an existing file 552, a first scenario exists in which a new file 556 may be created with data written to it and also named X, thereby replacing the existing file 552.

In a second scenario, existing file 552 is first deleted. Then a new file 556 may be created with data written to it and also named X and saved.

In a third scenario, existing file 552 is first renamed to Y. Then a new file 556 may be created with data written to it and named X and saved. Thereafter, file 552 may be deleted.

In a fourth scenario, existing file 552 is first renamed to Y. Then a new file 556 may be created with data written to it and named Z and saved. Thereafter, file 556 may be renamed to X. Furthermore, file 552 (now Y) may be deleted.

In this embodiment of the protocol, in step 510, a client may receive a request to delete, rename or replace an existing file 553 that is “in-sync” with (the same version) the version 552 stored on the server DS20 copy. The client preferably stores the last four deleted files as lost files. In step 512, the client creates a local copy of the existing file 553 with another filename identified as a lost file 555, and instructs the server to do the same 554 (a server may similarly create lost files when it receives a delete command regardless of its origin). Whenever the client receives a request to create a new file 556, 557 and write data to a new file, in step 520, the client looks to determine if a lost file of the same name exists. The client then checks in step 524 to make sure the same “lost file” 554 exists on the server and if so, the client determines a delta between the new file 557 and the lost file 555. Then in step 526, the client sends the server an indication to change the file identification of lost file 554 to that of new file 556 and use the former lost file as a new literal base for new file 556. The client sends the delta which applied to the newly renamed base file and version numbers are incremented. Then in step 528, the client then changes the file identification in the client cache.

If the client does not find a similar file, the entire new file is transferred to the server DS20. The DDFS system preferably only send delta or diff sections if the diff size is smaller than 25% of the plain text file size. If the delta files are too large, storing them may use an undesirable amount of space.

Several speculative diff optimizations are utilized. For example, a DDFS system preferably maintains the most recently deleted four files for each session on the client and server for a short period of time.

An alternative method may actually search and compare lost files to determine if there is a match. However, it is preferable to determine if a suitable lost file exists by examining the file name. For example, if a client has a lost file (as determined by seeing the same name in use) the server replies that it has the lost file or it does not have it. If the server has the lost file, only a diff is sent when the file is next committed to the server. Accordingly, a single transaction is used to create the file.

Referring to FIGS. 6A and 6B, a preferred remote client RC10 is described as in the first and second embodiments. As discussed above, the clients of a particular embodiment may utilize many different computing platforms 600. For example, a remote client RC10 is a Microsoft Windows ® Notebook PC. The DDFS client 610 is preferably software that maps one or more distributed DDFS network drives to the local file system. When that DDFS mapped network drive is accessed, the local cache 620 is used and the DDFS protocol is implemented. A platform-specific File System Driver 612 can be connected to a Non-platform specific Client Application Program Interface (API) 614 to handle the file manipulation calls supported by the platform 600. As described above, the client logic engine 616 uses the client cache system 620 and preferably a local file system to create delta versions, restore the latest version of a file and differentially transfer files. As can be appreciated, user interaction and settings may be obtained from a user utilizing well known techniques and a DDFS User Interface application 605.

As understood by one of ordinary skill in the art, the DDFS client can be configured to work with each supported platform.

As can be appreciated, dozens of file calls may be supported by a platform and supported by a file system driver. The DDFS client may utilize a platform specific API to interface the platform IFS Manager with a non-platform specific API and a generic client engine. In particular, the client engine logic can be disclosed with reference to examples of psuedo code for two common file functions known as open and commit. The psuedo code is illustrative and may be implemented on various platforms and similar psuedo code for the other file calls are apparent.

For example, an open file manager function may operate as follows:

BEGIN

check user permissions for the action required
open and lock the work file (internal to the implementation)
get the cached version of the file
if (cache is out of date or should lock the file in the server) then
BEGIN

ask the server for the last version (or a diff for it), and lock the file if needed

END

if (cache contains the last version of the file) then
BEGIN

put the data in the local work file
re-validate the cache

END

else

BEGIN

if new file is actually an empty file then

BEGIN

delete it from the cache /* we do not store empty files */

END

if (base file version is the same for cached and fetched files) then

BEGIN

patch the fetched diff from the server to the cached file
save the new file in the cache

END

else

BEGIN

patch the fetched file (combine base and diffs) to get the plain version of the file.
save the new file in the cache.

END

END

unlock the work file
if (server notified there are too many diffs) then

BEGIN

mark the file to send full version next time.

END

END

Similarly, a commit file manager function may operate as follows:

BEGIN

lock local work file
if (file is not an STF) then

BEGIN

if (we does not have to send full version and we have a base file and it is not empty) then

BEGIN

calculate diff between new file and base file (prev version)
check if diff succeeded

END

if (diff failed) then /* probably files are not similar */

BEGIN

create the full version of the file

END

send file prepared to the server
if server asked for full version next time, mark it.
store the just committed file in the cache (in plain format)
update local directory with the changes as returned from the server

END

else/* file is an STF */

BEGIN

update the modification time and the parent directory

END

unlock local work file
if this is the final commit (close) then
BEGIN

close the local work file

END

END

As can be appreciated from the disclosure set forth above, many additional file functions may be implemented.

Referring to FIG. 6C, a preferred cache server CS10 is described as in the first and second embodiments. As discussed above, the cache server may utilize many different computing platforms to implement a standard Network Filesystem server 650 interfaced to a DDFS client engine 660 through a Cache Server API 655. The cache server CS10 may accommodate the traffic of many clients on the NFS server 660 using well known techniques.

As understood by one of ordinary skill in the art, the DDFS cache server can be configured to work with each supported conventional network.

Referring to FIGS. 2E, 7A and 8B, a preferred DDFS gateway 830 is described as in the first embodiment. As discussed above, the gateway may utilize many different computing platforms to implement a standard Network Filesystem client 718 interfaced to a DDFS server function 710 that may accommodate the traffic of many clients on the DDFS server 710. A conventional Local File system 714 is utilized by the Gateway application Program 712 to store DDFS files.

Accordingly, the preferred DDFS Gateway 830 will receive a commit for a new version of a file 200 and store a new delta version. It will then reconstruct a plain text file 250 for the new version and store it on the conventional server 720. When plain text file 250 is successfully stored on the conventional server 720, the Gateway 830 reports that the file is safely stored.

As can be appreciated from FIG. 8B, a conventional client 850 may alter a plain text file on a conventional Network file server 836 that is also maintained in differential form by the DDFS Gateway 830. As can be appreciated, if conventional client 850 were not allowed access to the files 250, the system could be simpler. However, the Gateway Application Program logic 712 will wait for a file request and create a new diff section for the corresponding DDFS file 200 if needed.

Additionally, CIFS can be configured to send a notification when files are changed. In another embodiment, the Gateway Application Program logic 712 will recognize when the plain text file 250 is changed by a conventional client 850 and then create a new diff section for the corresponding DDFS file 200.

In the first embodiment, the Gateway will lock a file on the EFS if a remote user opens it for read/write, but not if it is opened for read only.

As understood by one of ordinary skill in the art, the DDFS gateway can be configured to work with each supported conventional network platform.

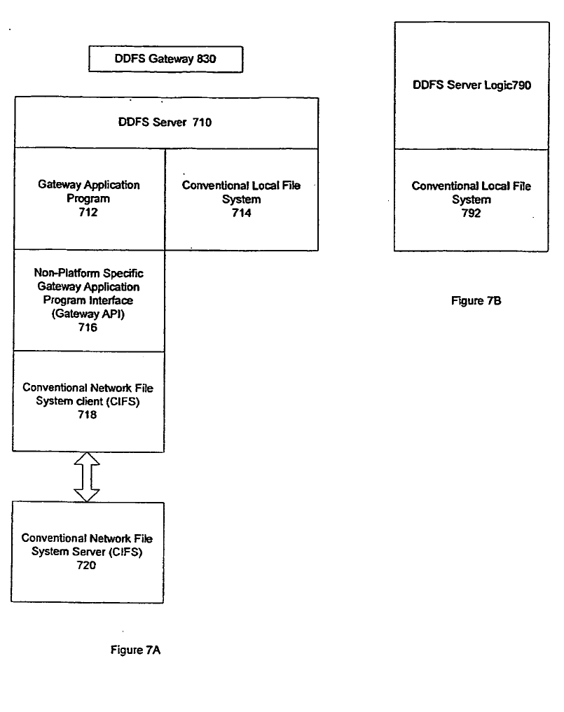

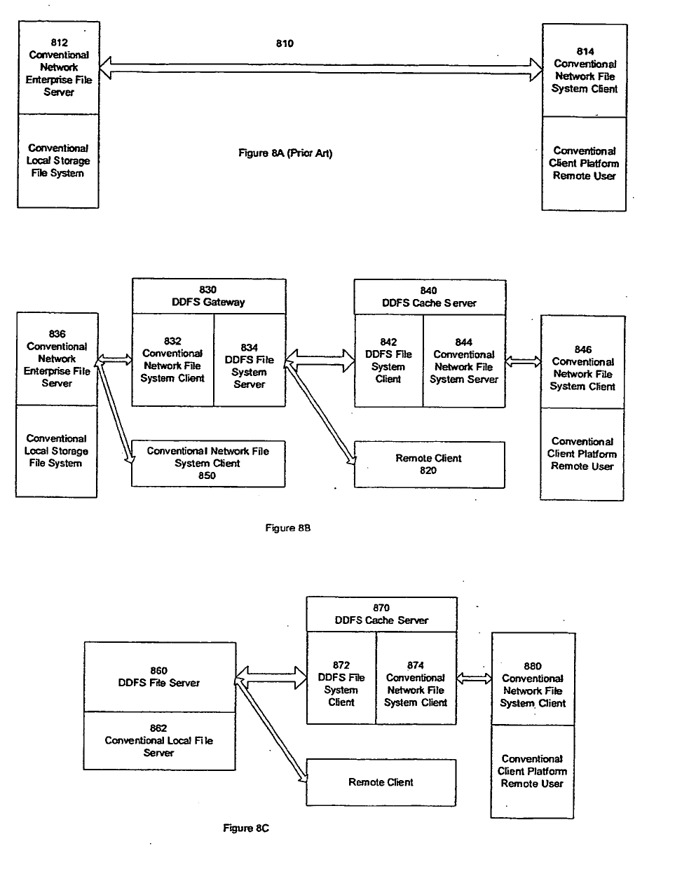

Referring to FIG. 7B, a stand alone DDFS server is disclosed as in the second embodiment The DDFS server comprises a conventional local file system 792, preferably a Linux based platform. A DDFS Server Logic 790 is connected to the local file system 792 and maintains DDFS files and services DDFS protocol requests from a plurality of remote clients.

The system of the invention may be configured to operate along with known distributed file system protocols by using “tunneling.” As shown in FIG. 8A, prior art distributed file systems have a server component 812 and a client component 814 that share data across a network 810. Local file systems and distributed file systems protocols are well known in the field. A common file server operating system such as the Windows NT Server may be installed on server 812 to control network communication across network 810 and may host distributed files using the CIFS distributed filesystem. A common client operating system such as the Windows NT client may be installed on client 814 and utilize a local filesystem such as a File Allocation Table (FAT) or the NTFS local file system. The Windows NT client 814 will then utilize CIFS to access the distributed files on the server 812. In such a system, the CIFS client 814 may send a request to the CIFS server to “read a file” or “write a file.” As can be appreciated, the CIFS protocol contains dozens of file requests that may be utilized. The CIFS server 812 receives the request and reads or writes the data to or from its local disk as appropriate. Finally, the CIFS server 812 sends the appropriate response to the CIFS client 814.

Distributed file systems such as CIFS and NFS are usually standard features of a network operating system. In order to preserve the use of the standard distributed file system protocols in each respective environment, tunneling may be used.

As shown in FIG. 8B, a DDFS system may utilize a DDFS gateway 830 as in the first embodiment. In such a configuration, conventional distributed file servers 836 may be utilized. A “full” tunneling behavior is preferably utilized to avoid installing additional software on a conventional network clients 846 and servers 836. A DDFS Cache Server 840 is connected to at least one conventional network client 846 across a conventional network 824. The DDFS Cache Server 840 includes a conventional network filesystem server 844 to for CIFS transmissions to client 846 and a DDFS client 842 for DDFS transmissions to the remote DDFS server. In other words, when acting as a CIFS server and receiving a request from a CIFS client such as a Windows® computer on network 824, the Cache Server 840 uses the DDFS protocol to transfer data to and from the DDFS File Server. Such behavior will be referred to as “tunneling” CIFS protocol files through the DDFS protocol.

For example, a conventional CIFS network client 846 sends a read file request to the CIFS server 844 in the DDFS cache server 840. The DDFS Cache Server 840 may act as a DDFS client 842 and processes the request by transmitting the request across network 810 using the DDFS protocol to the DDFS Server 834 in the DDFS Gateway 830. As disclosed with reference to the client logic, a DDFS Cache Server 840 may process a request without accessing the remote server in certain situations.

The DDFS Gateway 830 determines whether it can process the request without contacting the conventional CIFS server 836 and if so, it responds through the reverse path. If not, the DDFS Gateway 830 acts as a CIFS Client 832 and sends a standard CIFS request across network 822 using the CIFS protocol to the conventional CIFS server 836. The conventional CIFS server 836 sends the appropriate response to the CIFS Client 832 in the DDFS Gateway 830 and the response is sent to the conventional CIFS client 846 along the reverse path.

As shown in FIG. 7, a DDFS system as in the second embodiment may utilize a Storage Service Provider (SSP) model having a dedicated DDFS File Server 860 that includes a DDFS Server 862. In such a configuration, client side “half” tunneling behavior is preferably utilized to avoid installing additional software on a conventional network client 880. A DDFS Cache Server 870 is connected to at least one conventional network client 880 across a conventional network 854. The DDFS Cache Server 870 includes a conventional network filesystem server 874 to for CIFS transmissions to client 880 and a DDFS client 872 for DDFS transmissions to the remote DDFS server 820 across the network 850.

For example, a conventional CIFS network client 880 sends a read file request to the CIFS server 874 in the DDFS cache server 870. The DDFS Cache Server 870 acts as a DDFS client 872 and processes the request by transmitting the request across network 850 using the DDFS protocol to the DDFS File Server 860. The DDFS File Server 860 utilizes the DDFS Server 862 and responds to the request. The response is then sent to the conventional CIFS client 880 along the reverse path. As described above the procedure is known as tunneling. However, because only one DDFS to CIFS conversion takes place, this method is known as half tunneling.

As can be appreciated, the DDFS Cache Server CS10 may respond directly to a remote User client computer RU10 without querying the remote server in certain situations. For example, when processing a read-only file request, the DDFS Cache Server CS10 may respond directly to a remote User client computer RU10 without querying the remote server. However, for a write operation, the file must be locked on the remote server. Additionally a DDFS system may allow another session read access to a file locked by the client with out querying the server.

FIGS. 9A and 9B show a communications connection management state and process flow diagram and the associated files on a server according to another embodiment of the invention described with reference to the architecture shown in FIG. 1B. Computer Internetworking Communications systems are often described in terms of layers of a reference model. For example, the Open System Interconnection (OSI) model lists seven layers including session and transport layers and internetworking suites of protocols such as TCP/IP provide some or all of the functions of the layers. This embodiment will be described with reference to the OSI model and the TCP/IP suite, but other internetworking systems may be used. For example, a session layer may utilize TCP or UDP at the transport layer and either IP or PPP protocols at the network layer. However, various Asynchronous Transfer Mode (ATM) protocols suites and other suites may be utilized.

File system servers such as Differential Server DS20 often support very large number of users represented by Remote Clients RC10-11 and remote users RU10-11. It is contemplated that there may be millions of such users and that a good deal of network resources across network N10 will be utilized in maintaining connections to the file server while the client may not require a continuous connection. A period of interaction between a client and server is known as a session. An internetworking continuous connection from a client to a server may be maintained at the session level of an internetworking protocol and is known as a communications session. The TCP/IP suite may utilize several transport connections for a session. A TCP/IP connection is said to have a relation of many-to-one with the session as there can be any number, including zero, of TCP connections for one session.

Accordingly, in this embodiment, the TCP/IP connection at the transport layer can be disconnected from the network N10 until the user requires the connection. However, in a multi-user distributed file server, another user may wish to access a file that is locked by a first user. If the TCP/IP connection is closed, a conventional filesystem may not be able to ascertain if the first client is still using the file or not.

A communications session may utilize more than one underlying transport networking connection to accommodate a session according to this embodiment of the distributed filesystem protocol. Accordingly, this embodiment utilizes a process performing a time-out function associated with a connection to a server. Here a time-stamp and elapsed time measurement is made, while other embodiments such as an interrupt driven timer may be used. A client connection alive time-out reset “touch” is used to determine if a connection is actually still active. If not, the connection may be completely terminated and any files locked by that connection may be unlocked. For illustration purposes, a VPN TCP/IP connection using the Internet is described. The method applies equally to other connection methods described above with reference to FIG. 2.

Accordingly, in one embodiment, many users may connect to Differential Server DS20 through a VPN using TCP/IP across the Internet N10. This embodiment may be utilized on a Cache Server CS10 or a remote client RC10. When a client RC10 (or remote user RU10) connects to the server DS20, the client and server perform a hand-shaking and determine a session key for the session. They also have a session id associated with the session, and the server creates and maintains a session context file describing the session.

In this embodiment, the TCP/IP connection CR10 from Remote Client RC10 to the Differential Server DS20 may be closed when it is not needed, while being able to tell when the client is still active or not.

As shown in FIGS. 9A and 9B, a client RC10 connects to a distributed file server DS20 by performing handshaking and starting a session 900. The session 900 opens a new TCP/IP connection 910. The TCP/IP Connection services the session 900 and server DS20 sets a session context variable 993 in session context file 992 to CTX_Alive 912. The Session 900 utilizes a TCP/IP activity timer 912 to determine if the client does not communicate with the server using the TCP/IP connection for a certain amount of time known as the TCP/IP connection time out. If the client does not communicate with the server within the communication time out period, the server DS20 closes the TCP/IP connection 914. A separate timer process 913, in server DS20 tests the session context variable 993 every IAA_SERVER_TIMEOUT seconds and if the session context variable 993 time stamp is more than IAA_SERVER_TIMEOUT seconds old, it becomes CTX_WAIT_RECONNECT. The client RC10 identifies the TCP/IP connection socket closure but maintains the session data information. When the remote client RC10 user tries to perform an operation on the remote file system DS20, the client RC10 transparently creates a new TCP connection with the server DS20 and sends the session ID data. If the context variable has not been set to CTX_Dead or the context file already deleted, the server DS20 then finds the context file for that session and sets the session context variable 993 to CTX_ALIVE again 916.

During a session, the remote client RC10 may open a distributed file 990 and lock access to it. If a session 900 is in a CTX_WAIT_RECONNECT state, the client RC10 sends an “I am alive” packet 920 every IAA_SERVER_TIMEOUT seconds. In this embodiment, the I am alive packet is a UDP packet sent every IAA_SERVER_TIMEOUT/six seconds (this could be a longer time period). When the I am alive packet is received, the session context file 992 is “touched”—the server DS20 resets the session context file to the current time of arrival of the I am alive packet. Thereafter, as long as the session context file continues to be touched, the server DS20 may provide the client RC10 apparently seamless access to the distributed file 990 by reopening a TCP connection 916. If, however, the client RC10 does not “touch” the context file within a certain period of time that is equal to or greater than the IAA_SERVER_TIMEOUT value, the session 900 will time out. As can be appreciated, the UDP packet uses less resources than a TCP packet, but is not as reliable. There is no acknowledgement that the packet arrived safely. Accordingly, the system will wait until several UDP packets are missed before disabling a session. For example, if the time out value, one of the session variables 994, is set to 26 seconds, and the server does not receive one of the at least four “I am alive packets” sent in that time, the server DS20 determines that the context file is too old 924. The server DS20, then finds the session context file 992 for that session 900 and sets the session context variable 993 to CTX_WAIT_RECONNECT 928. The server DS20 has a garbage collector process 930 that will then periodically delete the session context file 992 if the session context variable is set to CTX_DEAD 932. The server must then manage the lock of files such as distributed file 990.

Server DS20 is accessible by many clients. If another session, for example, by client RC11, attempts to access the distributed file 990 that is locked by session 900, the server DS20 will determine if the session context variable 993 is marked CTX_ALIVE. If so, the lock request from client RC11 will be denied. If distributed file 990 is locked by a session 900 having a session context variable 993 marked CTX_WAIT_RECONNECT, the new lock request will be granted—and the distributed file 990 will be marked as locked by the new client RC11. In such a case, the original client will get an error message if it tries to access the file because it is no longer locked to that session.

If the session context variable 993 is marked CTX_DEAD, the new lock request is granted, and the distributed file 990 is marked as locked by the new client RC11. Of course, if a particular distributed file 990 is not locked, then the new lock request is granted, and the file is marked as locked by client RC11.

In another embodiment, a Gateway and a Cache server are implemented on the same computer and can be utilized as one or the other or both functions such that two separate DDFS paths may be implemented.

As can be appreciated an embodiment is described with reference to the CD-R appendix.

As can be appreciated, the methods, systems, articles of manufacture and memory structures described herein provide practical utility in fields including but not limited to file storage and retrieval and provide useful, concrete and tangible results including, but not limited to practical use of storage space and file transfer bandwidth.

As can be appreciated, the data processing mechanisms described may comprise standard general-purpose computers, but may comprise specialized devices or any data processor or manipulator. The mechanisms and processes may be implemented in hardware, software, firmware or combination thereof. As can be appreciated, servers may comprise logical servers and may utilize geographical load balancing, redundancy or other known techniques.

While the foregoing describes and illustrates embodiments of the present invention and suggests certain modifications thereto, those of ordinary skill in the art will recognize that still further changes and modifications may be made therein without departing from the spirit and scope of the invention. Accordingly, the above description should be construed as illustrative and is not meant to limit the scope of the invention. Rather, the scope of the invention is to be determined only by the appended claims and any expansion in scope of the literal claims allowed by law.

1-26. (canceled)

27. A method comprising:
(a) receiving, by a first tunneling device connected to a station over a first LAN, from the station, a user-transparent filesystem request to perform an operation on a file residing on a remote server across a WAN;
(b) tunneling the request over the WAN from the first tunneling device to a second tunneling device, the second tunneling device connected over a second LAN to the remote server;
(c) checking, by the second tunneling device, whether a first version of a file stored in the first tunneling device is identical to a second version of the file stored in the remote server;
(d) based on the checking result, determining, by the second tunneling device, if the request can be handled locally by the first tunneling device;
(e) if the determination result is negative:
(1) based on a comparison between the first version and the second version, creating a representation of a differential portion between the first version and the second version;
(2) sending the representation over the WAN from the second tunneling device to the first tunneling device;
(3) constructing, by the first tunneling device, based on the representation of the differential portion and based on the first version, a copy of the second version; and
(4) performing the filesystem request on said copy stored in the first tunneling device;
(f) permitting a computer, connected over the second LAN to the remote server, to alter the file residing on the remote server, using an access route exclusive of the first and second tunneling devices.

28. A method comprising:
storing on a server a file having a first version identifier;
storing on a first tunneling device and on a second tunneling device a first copy of the file having a second, different, version identifier;
receiving by the first tunneling device a filesystem request from a computing station to perform an operation on the file stored on the server, the filesystem request in accordance with a first communication protocol;
tunneling, by the first tunneling device to the second tunneling device, a tunneling request in accordance with a second communication protocol, the tunneling request indicating that the first tunneling device stores the copy of the file having the second version identifier;
reading, by the second tunneling device and from the server, the file having the first version identifier;
comparing, by the second tunneling device, the file having the first version identifier stored on the server, to the file having the second version identifier stored on the first tunneling device;
based on the comparison result, creating, by the second tunneling device, a representation of a differential portion between the file having the first version identifier and the file having the second version identifier;
tunneling, by the second tunneling device to the first tunneling device, the representation of the differential portion using single-transaction blocks aggregation;
constructing, by the first tunneling device, based on the representation of the differential portion and based on the copy of the file having the second version, a second copy of the file identical to the file stored on the server, the second copy automatically replacing one or more prior versions of the first copy;
performing the operation requested in the filesystem request on the second copy of the file stored in the first tunneling device.

29. The method of claim 28, wherein the method is for providing accelerated seamless file-access across a WAN having a local side and a remote side, the method comprising:
receiving, at the local side of the WAN, a filesystem request to perform an operation on a file stored on a server located at the remote side of the WAN;
determining whether at least a part of the operation can be handled at the local side of the WAN;
based on analysis of prior communications across the WAN, creating at the remote side of the WAN an optimized representation of one or more portions required to enable the local side of the WAN to handle the operation at the local side of the WAN;
sending the representation across the WAN from the remote side of the WAN to the local side of the WAN;
based on the received representation, handling the filesystem request at the local side of the WAN.

30. A system comprising:
a client-side unit connected over a WAN to a server-side engine,
the client-side unit connected over a first LAN to one or more client computers,
the server-side unit connected over a second LAN to a server,
the client-side engine comprising:
a cache to store items received over the WAN from the server-side engine;
an input unit to receive filesystem requests from the one or more client computers; and
a collator to collate the filesystem requests with items stored in the cache,
the server-side engine comprising:
an input unit to receive from the client-side engine an indication of one or more of the filesystem requests received by the client-side engine; and
an accelerator to send another request to the server based on the received indication, to receive a response from the server, and to create an optimized that enables the client-side engine to handle the requests.
